(19) United States
(12) Patent Application Publication
(10) Pub. No.: US 2024/0425077 A1
(43) Pub. Date: Dec. 26, 2024

(54) System and Method for Generating Driving Path in Vehicle

(71) Applicants: Hyundai Motor Company, Seoul (KR); Kia Corporation, Seoul (KR)

(72) Inventor: Sung Woo Choi, Seoul (KR)

(21) Appl. No.: 18/514,248

(22) Filed: Nov. 20, 2023

(30) Foreign Application Priority Data
Jun. 20, 2023 (KR) 10-2023-0079178

(51) Int. Cl. B60W 60/00

(52) U.S. Cl. CPC B60W 60/0011; B60W 2400/00; B60W 2556/50

(57) ABSTRACT

A system and a method for generating a driving path in a vehicle to provide a three point turn path are provided. The system includes a processor that receives a driving path from a navigation terminal. The processor determines whether there is a U-turn section on the driving path, determines whether it is impossible to make a U-turn without reversing in response to determining that there is the U-turn section on the driving path, and generates a three point turn path in response to determining that it is impossible to make the U-turn without reversing.

### CROSS-REFERENCE TO RELATED APPLICATION

This application claims the benefit of priority to Korean Patent Application No. 10-2023-0079178, filed in the Korean Intellectual Property Office on Jun. 20, 2023, the entire contents of which are incorporated herein by reference.

### TECHNICAL FIELD

The present disclosure relates to a system and a method for generating a driving path in a vehicle to provide a three point turn (or broken U-turn) path.

### BACKGROUND

An autonomous vehicle may recognize driving environments without manipulation of its driver to determine a risk and may plan a driving path to drive itself. The autonomous vehicle may plan a driving path with regard to various driving situations.

### SUMMARY

Systems, apparatuses, methods, and computer-readable media are described for generating a driving path in a vehicle, which may include a processor configured to receive, from a navigational terminal, a driving path. The processor may be further configured to, based on presence of a U-turn section on the driving path, determine that it is infeasible to make a single-move U-turn. The processor may be further configured to, based on the determination that it is infeasible to make a single-move U-turn, generate a three point turn path.

These and other features and advantages are described below in greater detail.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example system for generating a driving path in a vehicle;

FIG. 2 is a drawing for describing an example three point turn process associated with the present disclosure;

FIG. 3 is a flowchart illustrating an example method for generating a driving path;

FIG. 4 is a flowchart illustrating an example method for planning a three point turn path;

FIG. 5 is a drawing for describing an example method for planning a primary forwarding path;

FIG. 6 is a drawing for describing an example method for planning a reversing path;

FIGS. 7A and 7B are drawings for describing an example method for planning a reversing path;

FIGS. 8A and 8B are drawings for describing an example method for planning a secondary forwarding;

FIG. 9 is a drawing illustrating an example of generating a reversing path; and

FIG. 10 is a drawing illustrating an example of generating a secondary forwarding path.

### DETAILED DESCRIPTION

Hereinafter, some aspects of the present disclosure will be described in detail with reference to the drawings. In the drawings, the same reference numerals will be used throughout to designate the same or equivalent elements.

In describing examples according to the present disclosure, terms such as first, second, “A”, “B”, (a), (b), and the like may be used. These terms are only used to distinguish one element from another element, but do not limit the corresponding elements irrespective of the order or priority of the corresponding elements.

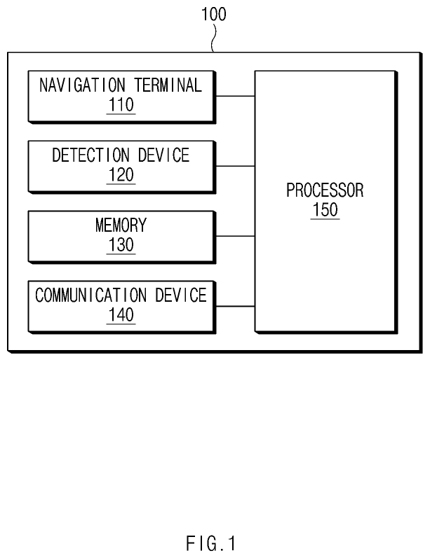

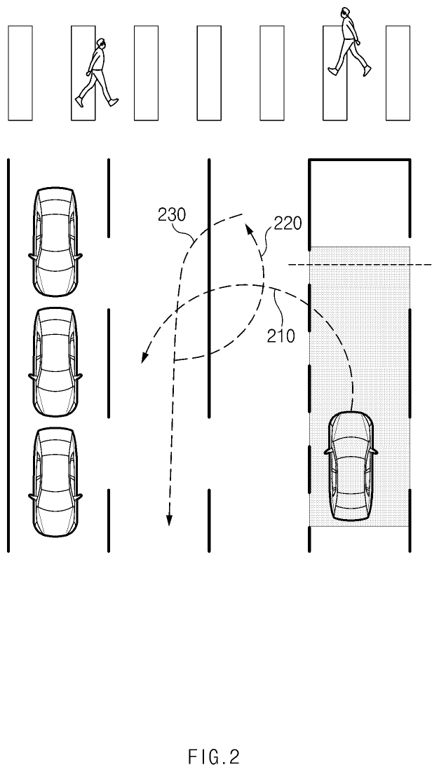

FIG. 1 is a block diagram illustrating a system for generating a driving path. FIG. 2 is a drawing for describing a three point turn process associated with the present disclosure.

A system 100 for generating a driving path (hereinafter referred to as a “system 100”) may be mounted on a vehicle loaded with an autonomous driving function. Referring to FIG. 1, the system 100 may include a navigation terminal 110, a detection device 120, a memory 130, a communication device 140, and/or a processor 150.

If a destination is set, the navigation terminal 110 may navigate a driving path from a starting point (e.g., a current position of the vehicle) to the destination and may guide a driver along the navigated driving path. The navigation terminal 110 may reflect real-time traffic information if navigating a driving path to search for an optimal path (e.g., the shortest distance, a minimum time, and/or the like). Although not illustrated in the drawing, the navigation terminal 110 may include a memory for storing map data, a global positioning system (GPS) receiver for measuring a position of the vehicle, a communication module for receiving traffic information from the outside, a processor for navigating a driving path and guiding the driver along the navigated driving path, and/or the like.

The detection device 120 may obtain surrounding information (e.g., a parked and stopped vehicle on the road, road state information, or the like) and/or driving information (e.g., a steering angle, a vehicle speed, or the like) using sensors (e.g., an ultrasonic sensor, radio detecting and ranging (RADAR), light detection and ranging (LiDAR), a steering angle sensor, a vehicle speed sensor, an inertial measurement unit (IMU), an image sensor, and/or the like).

The memory 130 may store specification information and/or predetermined setting information of the vehicle. The memory 130 may include a path generation algorithm or the like. The memory 130 may be a non-transitory storage medium which stores instructions executed by the processor 150. The memory 130 may be implemented as at least one of storage media (or recording media) such as a flash memory, a hard disk, a solid state disk (SSD), a random access memory (RAM), a static RAM (SRAM), a read only memory (ROM), a programmable ROM (PROM), an electrically erasable and programmable ROM (EEPROM), or an erasable and programmable ROM (EPROM).

The communication device 140 may support to establish a wired or wireless communication connection between the system 100 and an external electronic device (e.g., an electronic control unit (ECU) or the like) and perform communication through the established connection. The communication device 140 may include a communication processor, a communication circuit, an antenna, a transceiver, and/or the like.

The processor 150 may be connected with the navigation terminal 110, the detection device 120, the memory 130, and/or the communication device 140 over an in-vehicle network. The processor 150 may interwork with the navigation terminal 110, the detection device 120, the memory 130, and/or the communication device 140 to control the overall operation of the system 100. The processor 150 may be implemented as at least one of processing devices such as an application specific integrated circuit (ASIC), a digital signal processor (DSP), a programmable logic device (PLD), a field programmable gate array (FPGA), a central processing unit (CPU), a microcontroller, or a microprocessor.

The processor 150 may receive the driving path from the navigation terminal 110. The processor 150 may identify whether there is a U-turn section in front of the vehicle based on the received driving path. The processor 150 may identify whether there is a U-turn section within a predetermined distance (e.g., 20 m) in front of the vehicle on the driving path.

If there is the U-turn section in front of the vehicle, the processor 150 may identify whether it is possible to make a U-turn without reversing in the U-turn section (e.g., a single-move U-turn). If the vehicle enters the U-turn section, the processor 150 may determine whether it is possible to make a U-turn without reversing based on surrounding information detected by the detection device 120 and/or road information extracted from map data. For example, if the road width is narrow to make a U-turn without reversing or if there is a parked and stopped vehicle on the U-turn path, the processor 150 may determine that it is impossible and/or infeasible to make the U-turn without reversing. The processor 150 may determine whether the road width is sufficient to make a U-turn without reversing based on a minimum turning radius of the vehicle. In other words, if the road width is less than the minimum turning radius of the vehicle, the processor 150 may determine that it is impossible and/or infeasible to make a U-turn without reversing. For example, if the road width is sufficient to make the U-turn without reversing or if there is no parked and/or stopped vehicle on the U-turn path, the processor 150 may determine that it is possible and/or practical to make the U-turn.

If it is possible and/or practical to make the U-turn, the processor 150 may generate (or plan) a U-turn path which does not include a reversing path (or a U-turn path). The processor 150 may generate the U-turn path using a U-turn path generation algorithm.

If it is impossible and/or infeasible to make the U-turn without reversing, the processor 150 may generate a U-turn path including a reversing path (or a three point turn path). Referring to FIG. 2, a U-turn with reversing (or backing up) may be generally performed with a primary forwarding step 210, a reversing step 220, and a secondary forwarding step 230. Thus, the three point turn path may include a primary forwarding path, a reversing path, and a secondary forwarding path. The case where the processor 150 generates the U-turn path with one-time reversing is described as an example, but the present disclosure is not limited thereto. The processor 150 may generate a U-turn path with two times or more reversing.

The processor 150 may output the generated U-turn path to the navigation terminal 110 and/or a vehicle controller (not shown). The navigation terminal 110 may display the U-turn path on its display screen. The vehicle controller (not shown) may control a behavior (e.g., steering, braking, acceleration, deceleration, and/or the like) of the vehicle such that the vehicle follows the U-turn path.

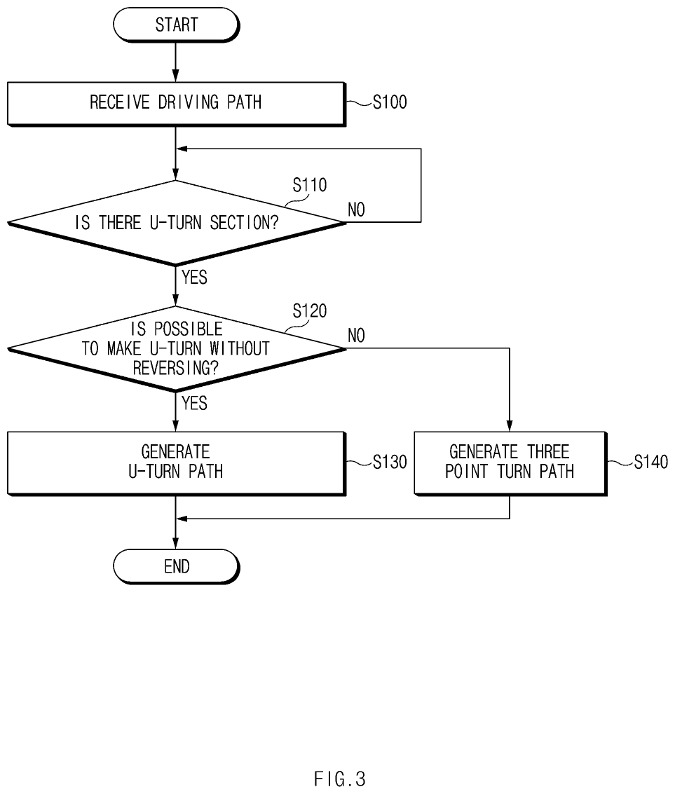

FIG. 3 is a flowchart illustrating a method for generating a driving path.

Referring to FIG. 3, in S100, a processor 150 of a system 100 for generating a driving path in FIG. 1 may receive a driving path from a navigation terminal 110 of FIG. 1. The navigation terminal 110 may navigate a driving path from a starting point of the vehicle to a destination of the vehicle and may transmit the navigated driving path to the processor 150.

In S110, the processor 150 may determine whether there is a U-turn section in front of the vehicle based on the received driving path. The processor 150 may identify whether there is a U-turn section within a predetermined distance in front of the vehicle on the driving path.

If it is determined that there is the U-turn section in front of the vehicle, the processor 150 may identify whether it is possible to make a U-turn without reversing in the U-turn section. If the vehicle enters the U-turn section, the processor 150 may determine whether it is possible to make a U-turn without reversing based on surrounding information detected by a detection device 120 of FIG. 1 and/or road information extracted from map data. For example, if the road width is narrow to make a U-turn without reversing or if there is a parked and stopped vehicle on the U-turn path, the processor 150 may determine that it is impossible and/or infeasible to make the U-turn. For example, if the road width is sufficient to make the U-turn without reversing or if there is no parked and stopped vehicle on the U-turn path, the processor 150 may determine that it is possible to make the U-turn without reversing.

If it is possible to make the U-turn without reversing, in S130, the processor 150 may generate (or plan) a U-turn path which does not include a reversing path (or a U-turn path). The processor 150 may generate the U-turn path using a U-turn path generation algorithm.

If it is impossible and/or infeasible to make the U-turn without reversing, in S140, the processor 150 may generate a U-turn path including a reversing path (or a three point turn path). The three point turn path may include a primary forwarding path, a reversing path, and a secondary forwarding path.

The processor 150 may output the generated U-turn path to the navigation terminal 110 and/or a vehicle controller (not shown). The navigation terminal 110 may display the U-turn path on its display screen. The vehicle controller (not shown) may control a behavior of the vehicle such that the vehicle follows the U-turn path.

The case where the processor 150 generates the U-turn path or the three point turn (or broken U-turn) path and controls the vehicle to drive along the U-turn path is described as an example, but the present disclosure is not limited thereto. The processor 150 may generate a primary forwarding path on the three point turn path, may control driving of the vehicle along the primary forwarding path to generate a reversing path, may move the vehicle along the reversing path to generate a second forwarding path, and may control the vehicle to follow the second forwarding path. Alternatively, the processor 150 may generate a primary forwarding path on the three point turn path and may control driving of the vehicle along the primary forwarding path to generate a reversing path. Thereafter, the processor 150 may move the vehicle along the primary forwarding path, may control a behavior of the vehicle along the generated reversing path to generate a secondary forwarding path, and may control driving of the vehicle along the secondary forwarding path if the control of the vehicle to follow the reversing path is ended.

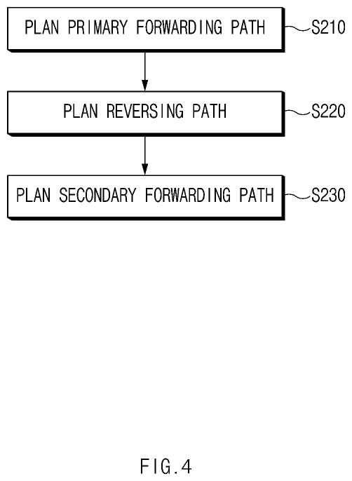

FIG. 4 is a flowchart illustrating a method for planning a three point turn path.

Referring to FIG. 4, in S210, a processor 150 of FIG. 1 may plan a primary forwarding path. The processor 150 may generate the primary forwarding path with regard to a road width, a minimum turning radius of the vehicle, and/or the like. The processor 150 may set a target path to be entered by making a U-turn. The processor 150 may generate a U-turn path for entering the set target path, that is, the primary forwarding path, using U-turn path plan technology. The processor 150 may identify there is a parked and stopped vehicle on a U-turn path using a detection device 120 of FIG. 1. If there is the parked and stopped vehicle on the primary forwarding path, the processor 150 may move the vehicle to a point at which the vehicle does not collide with the parked and stopped vehicle.

In S220, the processor 150 may plan a reversing path based on an end point of the primary forwarding path. The processor 150 may separately generate a reversing path, if the vehicle sufficiently reverses (or backs up) in a reversible area and if the vehicle reverses to a minimum. If the vehicle sufficiently reverses in the reversible area, the processor 150 may generate a reversing path with a minimum turning radius with respect to the center of the front bumper of the vehicle. If the vehicle reverses to the minimum and if the vehicle reverses with maximum steering and performs maximum steering in an opposite direction to move forward, the processor 150 may calculate a minimum reversing point such that a right corner point of the front bumper does not collide with the parked and stopped vehicle.

In S230, the processor 150 may plan a secondary forwarding path based on the end point of the reversing path. If the vehicle sufficiently reverses in the reversible area, the processor 150 may calculate an arc path for allowing the vehicle to immediately enter the target path. If the vehicle reverses to the minimum, the processor 150 may plan the secondary forwarding path such that the vehicle drives to the minimum turning radius.

The case where it is impossible and/or infeasible to make the U-turn with reversing due to the parked and stopped vehicle is described as an example, but the present disclosure is not limited thereto. It may be impossible and/or infeasible to make a U-turn with reversing due to a possibility of colliding with an object such as a curb stone, a roadside facility, or the like.

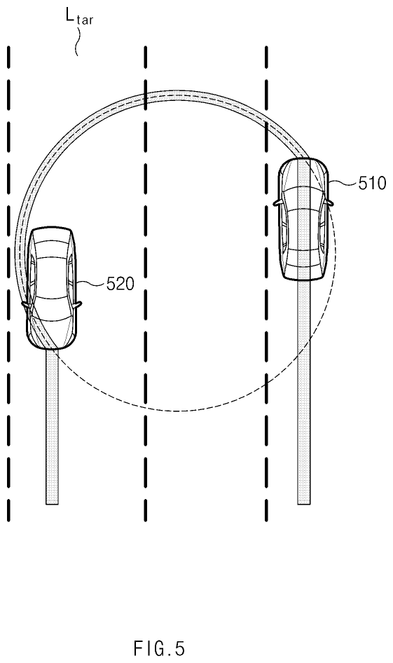

FIG. 5 is a drawing for describing an example method for planning a primary forwarding path.

If an autonomous vehicle 510 should make a U-turn on a driving path, a processor 150 of a system 100 for generating a driving path, which is loaded into the autonomous vehicle 510, may set a lane to be entered by making a U-turn if the autonomous vehicle 510 enters a U-turn section to a target lane Lₜₐᵣ. The processor 150 may plan a path for allowing the autonomous vehicle 510 to make a U-turn to enter the target lane Lₜₐᵣ, that is, a primary forwarding path. At this time, the processor 150 may plan the primary forwarding path using a previously well-known U-turn path plan method.

The autonomous vehicle 510 may perform autonomous driving along the planned primary forwarding path. At this time, if there is a parked and stopped vehicle 520 on the target lane Lₜₐᵣ, the autonomous vehicle 510 may drive along the planned primary forwarding path, which may move to only a point at which the autonomous vehicle 510 does not collide with the parked and stopped vehicle 520. In other words, the autonomous vehicle 510 may stop at a point where the distance from the parked and stopped vehicle 520 reaches a predetermined threshold distance.

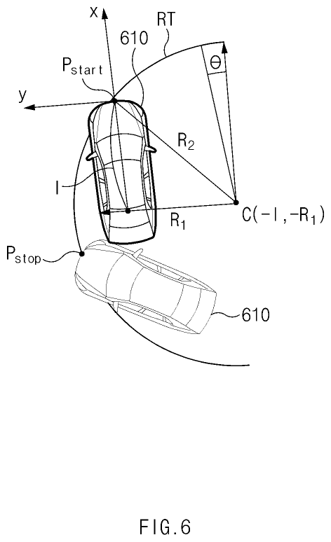

FIG. 6 is a drawing for describing an example method for planning a reversing path.

An autonomous vehicle 610 may perform primary forwarding driving along a primary forwarding path and may plan a reversing path based on a point at where the autonomous vehicle 610 ends the primary forwarding driving. A processor 150 of a system 100 for generating a driving path in the autonomous vehicle 610 may calculate an arc with a minimum turning radius with respect to the center of the front bumper of the autonomous vehicle 610 and may generate a reversing path RT.

If the center of the front bumper of the autonomous vehicle 610 is the origin (0, 0), the processor 150 may represent a rotational center of the autonomous vehicle 610 as C(−1, −R₁) on a polar coordinate system. Herein, I may refer to the distance from the center of the front bumper of the autonomous vehicle 610 to the center of the rear axle of the autonomous vehicle 610, that is, the sum of the front over hang and the wheel base of the autonomous vehicle 610, and R₁ may refer to the distance from the rotational center C(−1, −R₁) of the autonomous vehicle 610 to the center of the rear axle of the autonomous vehicle 610.

The processor 150 may calculate an arc point where a minimum turning radius R2 with respect to the center of the front bumper of the autonomous vehicle 610 is a radius. At this time, the processor 150 may gradually increase a central angle θ of the arc from 0 degree to a predetermined angle A and may calculate an arc point. Herein, A may be determined as a value enough to cover a reversible area. The processor 150 may generate an arc path composed of the calculated arc points, that is, the reversing path RT.

If the reversing path RT is planned, the autonomous vehicle 610 may sufficiently reverse in the reversible area based on the planned reversing path RT. For example, the autonomous vehicle 610 may set its current position to a reversing start point Pₛₜₐᵣₜ on the reversing path RT and may reverse from the reversing start point Pₛₜₐᵣₜ to a reversing end point Pₛₜₒₚ along the reversing path RT.

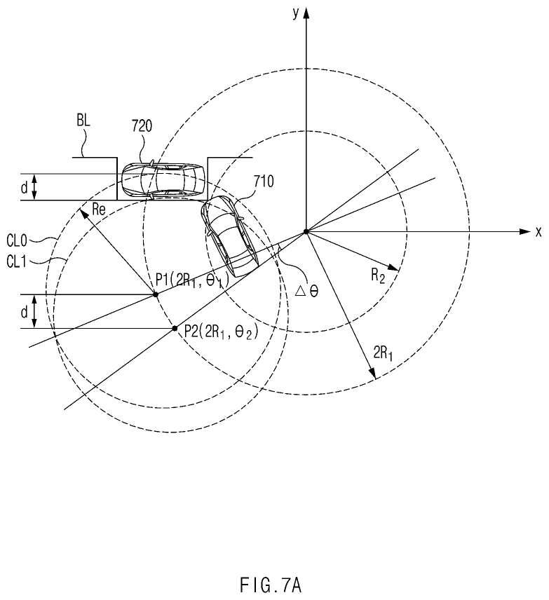

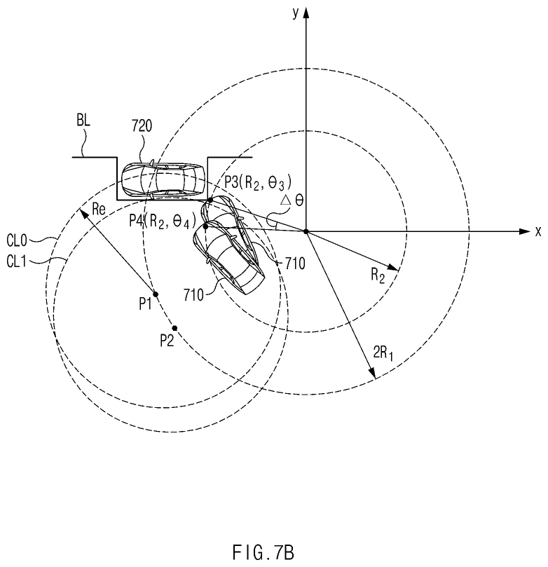

FIGS. 7A and 7B are drawings for describing an example method for planning a reversing path.

If there is a parked and stopped vehicle 720 on a primary forwarding path if an autonomous vehicle 710 drives along the primary forwarding path, the autonomous vehicle 710 may stop if the distance from the parked and stopped vehicle 720 reaches a predetermined threshold distance. If reversing with maximum steering and moving forward with maximum steering in an opposite direction, the autonomous vehicle 710 may calculate a rotational center angle required such that the parked and stopped vehicle 720 and a right corner point of the front bumper of the autonomous vehicle 710 do not collide with each other. The autonomous vehicle 710 may calculate a minimum reversing point based on the calculated rotational center angle.

In detail, a processor 150 of a system 100 for generating a driving route in the autonomous vehicle 710 may set a coordinate axis of a polar coordinate system such that the parked and stopped vehicle 720 and the x-axis are parallel to each other at a point where the autonomous vehicle 710 stops for reversing.

The processor 150 may manipulate the steering wheel with maximum steering and may calculate a turning path CL0 and a border line BL of the parked and stopped vehicle 720 if the autonomous vehicle 710 drives forward. The center point of the turning path CL0 may be P1 (2R₁, θ1).

The processor 150 may calculate a difference d between a maximum value on the y-axis of the turning path CL0 and a minimum value on the y-axis of the border line BL.

The processor 150 may generate a turning path CL1 for allowing the autonomous vehicle 710 not to collide with the parked and stopped vehicle 720 if the autonomous vehicle 710 drives forward to a minimum turning radius based on the calculated difference d. The center point of the turning path CL1 may be P2 (2R₁, θ1).

The processor 150 may calculate a rotational center angle Δθ between P1 and P2 using Equations 1 to 4 below.

$$d = {y}_{P 1} - {y}_{P 2} = {y}_{P 1} - 2 R i * sin {θ}_{2} \qquad [ Equation 1 ]$$

$${θ}_{2} = a sin ( \frac{d - {y}_{P 1}}{2 R i} ) \qquad [ Equation 2 ]$$

$${θ}_{1} = a sin ( \frac{{y}_{P 1}}{2 R i} ) \qquad [ Equation 3 ]$$

$$Δθ = {θ}_{2} - {θ}_{1} \qquad [ Equation 4 ]$$

Herein, Ri is the distance from the rotational center of the vehicle to the center of the rear axle of the vehicle, θ2 is the angle if P2 is displayed with the polar coordinate system (i.e., the angle from the x-axis to P2), and θ1 is the angle if P1 is displayed with the polar coordinate system (i.e., the angle from the x-axis to P1).

The processor 150 may calculate a point P4 where the center P3 of the front bumper of the autonomous vehicle 710 moves by Δθ using Equations 5 to 7 below.

$${x}_{P 4} = R cos {θ}_{4} \qquad [ Equation 5 ]$$

$${y}_{P 4} = R sin {θ}_{4} \qquad [ Equation 6 ]$$

$${θ}_{4} = {θ}_{3} + Δ θ \qquad [ Equation 7 ]$$

Thereafter, the autonomous vehicle 710 may move backward with maximum steering until the center of the front bumper of the autonomous vehicle 710 reaches P4 from P3.

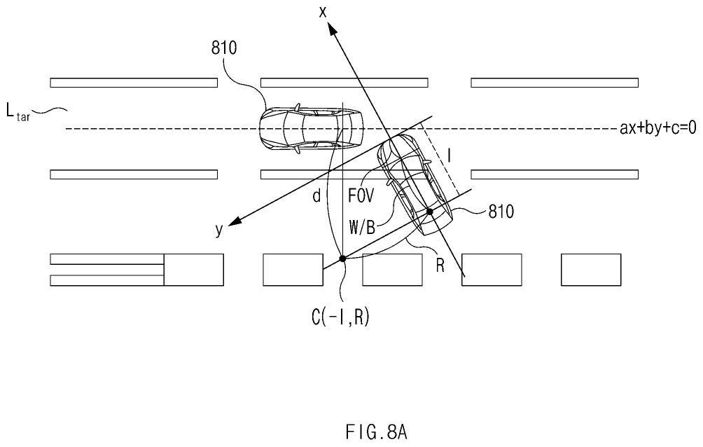

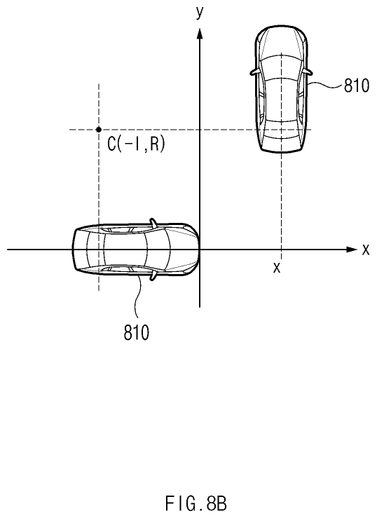

FIGS. 8A and 8B are drawings for describing an example method for planning a secondary forwarding path.

If an autonomous vehicle 810 sufficiently reverses in a reversible area to stop, a system 100 for generating a driving path in the autonomous vehicle 810 may calculate an arc path for allowing the autonomous vehicle 810 to immediately enter a target lane from a current posture of the autonomous vehicle 810. At this time, the system 100 for generating the driving path may calculate an arc path using a turning radius and a rotational center of an arc.

The system 100 for generating the driving path may calculate a radius R using the case where a distance between the straight line of the target lane Lₜₐᵣ and the rotational center becomes the turning radius of the arc.

First of all, a processor 150 of the system 100 for generating the driving path may calculate an equation (ax+by +c=0) of the straight line of the target lane Lₜₐᵣ. Referring to FIG. 8B, the processor 150 may obtain an equation (x=x₁) of the straight line of the target lane Lₜₐᵣ.

Next, the processor 150 may calculate a turning radius R(=1+x₁) of the arc based on the equation of the straight line of the target lane Lₜₐᵣ. Herein, the turning radius of the arc may be represented as Equation 8 below.

$$d = \frac{\vert {ax}_{1} + b {y}_{1} + c \vert}{\sqrt{{a}^{2} + {b}^{2}}} = \frac{\vert - al + bR + c \vert}{\sqrt{{a}^{2} + {b}^{2}}} = R \qquad [ Equation 8 ]$$

Herein, 1 is the value obtained by adding the front over hang (FOV) of the vehicle and the wheel base (W/B), which refers to the distance from the center of the front bumper of the vehicle to the center of the rear axle of the vehicle. \sqrt{a²+b²}=e and −al+c=fare substituted in Equation 8 above to be simplified.

$$R = \frac{f}{e - b} ,$$

if bR+f≥0, and

$$R = \frac{- f}{e + b} ,$$

if bR+f<0.

Finally, the processor 150 may calculate an arc path point. The processor 150 may calculate an arc point where the center of the front bumper of the autonomous vehicle 810 is the origin, if the rotational center is C(−1, R), and where the minimum turning radius R2 with respect to the center of the front bumper is the radius. At this time, the processor 150 may gradually increase a central angle θ of the arc from −π/2 (on the y-axis) to a predetermined angle B and may calculate the arc point. Herein, B is the angle required to align vehicle heading on the target lane, which may be calculated.

Additionally or alternatively, if the autonomous vehicle 810 reverses to a minimum, the processor 150 may generate a forwarding path with respect to the center of the front bumper of the autonomous vehicle 810. At this time, the processor 150 may generate an arc path where the minimum turning radius R2 is the radius as a secondary forwarding path.

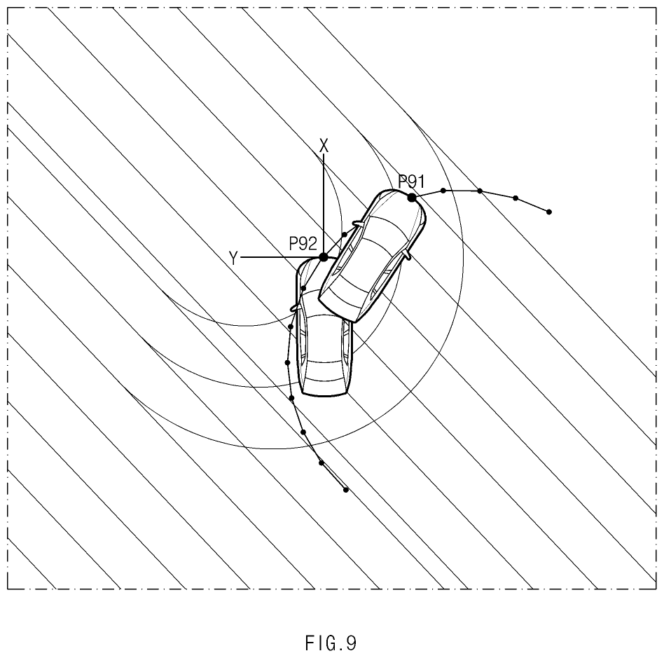

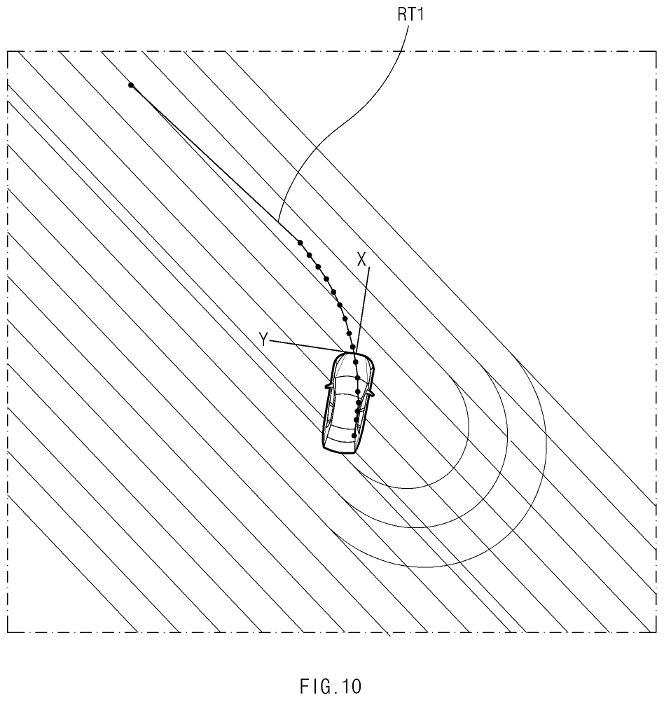

FIG. 9 is a drawing illustrating an example of generating a reversing path. FIG. 10 is a drawing illustrating an example of generating a secondary forwarding path.

As shown in FIG. 9, if a reversing path is generated, an autonomous vehicle may set its current position to a reversing start point P91 based on the reversing path and may reverse to a reversing end point P92.

After completing reversing to the reversing end point P92, the autonomous vehicle may generate a secondary forwarding path RT1. The autonomous vehicle may drive forward along the secondary forwarding path RT1 to enter a target lane.

Embodiments of the present disclosure may generate and provide a U-turn path with reversing (or three point turn) if generating the U-turn path for autonomous driving, thus avoiding a collision with a vehicle parked and stopped on a target lane and safely making the U-turn.

Furthermore, aspects of the present disclosure may be directed to making a U-turn by minimally reversing.

Furthermore, aspects of the present disclosure may be directed to planning and providing a three point turn path with respect to the center of the front bumper of the vehicle with regard to a kinematic feature of the vehicle, such that the vehicle may easily follow the planned U-turn path.

An aspect of the present disclosure provides a system and a method for generating a driving path in a vehicle to generate and provide a U-turn path with reversing (or backing up) when generating the U-turn path for autonomous driving.

Another aspect of the present disclosure provides a system and a method for generating a driving path in a vehicle to provide a path for making a U-turn by minimally reversing.

Another aspect of the present disclosure provides a system and a method for generating a driving path in a vehicle to plan and provide a three point turn path with respect to the center of the front bumper with regard to a kinematic feature of the vehicle.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a system for generating a driving path in a vehicle may include a processor that receives a driving path from a navigation terminal. The processor may determine whether there is a U-turn section on the driving path, may determine whether it is impossible to make a U-turn without reversing in response to determining that there is the U-turn section on the driving path, and may generate a three point turn path in response to determining that it is impossible to make the U-turn without reversing.

The processor may generate the three point turn path including a primary forwarding path, a reversing path, and a secondary forwarding path.

The processor may set a target lane to be entered by making the U-turn and may generate a U-turn path for entering the target lane as a primary forwarding path.

The vehicle may drive along the primary forwarding path until a distance between the vehicle and an object located on the primary forwarding path reaches a predetermined threshold distance.

The processor may calculate arc points where a minimum turning radius with respect to the center of a front bumper of the vehicle is a radius and generates a reversing path based on the calculated arc points.

The processor may calculate a rotational center angle for a corner point of a front bumper of the vehicle not to collide with an object in response that the vehicle moves forward to a minimum turning radius and may calculate a minimum reversing point of the vehicle based on the rotational center angle.

The vehicle may move backward with maximum steering to the minimum reversing point.

The processor may calculate an equation of a straight line of a target lane, may calculate a turning radius of the vehicle based on the equation of the straight line, and may generate a secondary forwarding path based on the turning radius of the vehicle.

The processor may calculate arc points where a minimum turning radius with respect to the center of a front bumper of the vehicle is a radius and may generate a secondary forwarding path based on the calculated arc points.

The processor may determine whether it is impossible to make the U-turn without reversing based on at least one of surrounding information detected by a detection device or road information extracted from map data, or any combination thereof.

According to another aspect of the present disclosure, a method for generating a driving path in a vehicle may include receiving a driving path from a navigation terminal, determining whether there is a U-turn section on the driving path, determining whether it is impossible to make a U-turn without reversing in response to determining that there is the U-turn section on the driving path, and generating a three point turn path in response to determining that it is impossible to make the U-turn without reversing.

The generating of the three point turn path may include planning a primary forwarding path, planning a reversing path, and planning a secondary forwarding path.

The planning of the primary forwarding path may include setting a target lane to be entered by making the U-turn and generating a U-turn path for entering the target lane as the primary forwarding path.

The planning of the primary forwarding path may further include allowing the vehicle to drive along the primary forwarding path until a distance between the vehicle and an object located on the primary forwarding path reaches a predetermined threshold distance.

The planning of the reversing may include calculating arc points where a minimum turning radius with respect to the center of a front bumper of the vehicle is a radius and generating the reversing path based on the calculated arc points.

The planning of the reversing path may include calculating a rotational center angle for a corner point of a front bumper of the vehicle not to collide with an object in response that the vehicle moves forward to a minimum turning radius and calculating a minimum reversing point of the vehicle based on the rotational center angle.

The planning of the reversing path may further include allowing the vehicle to move backward with maximum steering to the minimum reversing point.

The planning of the secondary forwarding path may include calculating an equation of a straight line of a target lane, calculating a turning radius of the vehicle based on the equation of the straight line, and generating the secondary forwarding path based on the turning radius of the vehicle.

The planning of the secondary forwarding path may include calculating arc points where a minimum turning radius with respect to the center of a front bumper of the vehicle is a radius and generating the secondary forwarding path based on the calculated arc points.

The determining of whether it is impossible to make the U-turn without reversing may include determining whether it is impossible to make the U-turn without reversing, based on at least one of surrounding information detected by a detection device or road information extracted from map data, or any combination thereof.

All descriptions herein of actions of a processor may comprise actions caused by one or more processors.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims. Therefore, examples of the present disclosure are not intended to limit the technical spirit of the present disclosure, but provided only for the purpose of illustration. The scope of the present disclosure should be construed on the basis of the accompanying claims, and all the technical ideas within the scope equivalent to the claims should be included in the scope of the present disclosure.

What is claimed is:

1. A system for a vehicle, the system comprising:
a processor configured to:
receive, from a navigation terminal, a driving path;
based on presence of a U-turn section on the driving path, determine that it is infeasible to make a single-move U-turn; and
based on the determination that it is infeasible to make the single-move U-turn, generate a three point turn path for the U-turn section.

2. The system of claim 1, wherein the processor is further configured to generate the three point turn path including a primary forward path, a reverse path, and a secondary forward path.

3. The system of claim 1, wherein the processor is further configured to:
set a target lane to be entered by the three point turn path; and
generate the three point turn path for entering the target lane as a primary forward path.

4. The system of claim 3, wherein the vehicle is configured to drive along the primary forward path until a distance between the vehicle and an object located on the primary forward path reaches a predetermined threshold distance.

5. The system of claim 1, wherein the processor is further configured to;
calculate arc points for a minimum turning radius with respect to a center of a front bumper of the vehicle; and
generate a reverse path based on the calculated arc points.

6. The system of claim 1, wherein the processor is further configured to:
calculate a rotational center angle so that a corner point of a front bumper of the vehicle avoids colliding with an object, such that, based on the calculated rotational center angle, the vehicle moves forward to a minimum turning radius; and
calculate a minimum reverse point of the vehicle based on the rotational center angle.

7. The system of claim 6, wherein the vehicle is configured to move backward with maximum steering to the minimum reverse point.

8. The system of claim 1, wherein the processor is further configured to:
calculate an equation of a substantially straight line of a target lane;
calculate a turning radius of the vehicle based on the equation of the substantially straight line; and
generate a secondary forward path based on the turning radius of the vehicle.

9. The system of claim 1, wherein the processor is further configured to:
calculate arc points for a minimum turning radius with respect to a center of a front bumper of the vehicle; and
generate a secondary forward path based on the calculated arc points.

10. The system of claim 1, wherein the processor is further configured to determine that it is infeasible to make the single-move U-turn based on at least one of surrounding information detected by a detection device or road information extracted from map data.

11. A method for a vehicle, the method comprising:
receiving a driving path from a navigation terminal;
determining that there is a U-turn section on the driving path;
based on the determination that there is a U-turn section on the driving path, determining that it is infeasible to make a single-move U-turn; and
generating a three point turn path for the U-turn section in response to determining that it is infeasible to make the single-move U-turn.

12. The method of claim 11, wherein the generating of the three point turn path comprises:
planning a primary forward path;
planning a reverse path; and
planning a secondary forward path.

13. The method of claim 12, wherein the planning of the primary forward path comprises:
setting a target lane to be entered by making the three point turn path; and
generating the three point turn path for entering the target lane as the primary forward path.

14. The method of claim 13, further comprising:
allowing the vehicle to drive along the primary forward path until a distance between the vehicle and an object located on the primary forward path reaches a predetermined threshold distance.

15. The method of claim 12, wherein the planning of the reverse path comprises:
calculating arc points for a minimum turning radius with respect to a center of a front bumper of the vehicle; and
generating the reverse path based on the calculated arc points.

16. The method of claim 12, wherein the planning of the reverse path comprises:
calculating a rotational center angle so that a corner point of a front bumper of the vehicle avoids colliding with an object, such that, based on the calculated rotational center angle, the vehicle moves forward to a minimum turning radius; and
calculating a minimum reverse point of the vehicle based on the rotational center angle.

17. The method of claim 16, further comprising:
causing the vehicle to move backward with maximum steering to the minimum reverse point.

18. The method of claim 12, wherein the planning of the secondary forward path comprises:
calculating an equation of a substantially straight line of a target lane;
calculating a turning radius of the vehicle based on the equation of the substantially straight line; and
generating the secondary forward path based on the turning radius of the vehicle.

19. The method of claim 12, wherein the planning of the secondary forward path comprises:
calculating arc points for a minimum turning radius with respect to a center of a front bumper of the vehicle; and
generating the secondary forward path based on the calculated arc points.

20. The method of claim 11, wherein the determining that it is infeasible to make the single-move U-turn comprises:
determining that it is infeasible to make the single-move U-turn, based on at least one of surrounding information detected by a detection device or road information extracted from map data.
